(19) United States
(12) Patent Application Publication
(10) Pub. No.: US 2013/0233713 A1
(43) Pub. Date: Sep. 12, 2013

(54) ELECTROCOALESCENT FLUID PHASE SEPARATION APPARATUS AND METHOD

(71) Applicants: RICARDO J. CARRIZO M., Maracaibo (VE); Rodolfo J. Salas A., Maracaibo (VE); Humberto C. Herrera M., Maracaibo (VE)

(72) Inventors: RICARDO J. CARRIZO M., Maracaibo (VE); Rodolfo J. Salas A., Maracaibo (VE); Humberto C. Herrera M., Maracaibo (VE)

(21) Appl. No.: 13/417,779

(22) Filed: Mar. 12, 2012

(51) Int. Cl. C02F 1/46; C02F 1/48

(52) U.S. Cl. 204/557; 204/670; 204/554

(57) ABSTRACT

An apparatus and related methods for optimizing component separation within a fluid using a direct current electric field. The unique sequence and arrangement of concentrically interleaved electrodes increases reactive surface area, decreases time fluid remains within the reactor, and decreases the size of the reaction vessel.

### FIELD OF THE INVENTION

The present invention relates to the field of fluid phase separation and, more particularly, to water treatment and related methods. More specifically, the present invention relates to a device for separating various components present in a fluid, depending on fluid viscosity and thixotropy.

### BACKGROUND OF THE INVENTION

Separating components from Newtonian fluids, such as contaminants from waste water, is necessary for numerous industrial processes. Many methods for component separation exist, such a filtration, chemical treatment, and reverse osmosis. These methods, however, suffer from a number of limitations.

Chemical treatments are typically extremely pollutant-specific. Additionally, the chemicals used to separate components from the fluid often require removal from the solution or mixture themselves, adding cost and complexity to the process. These methods also involve large and complex mixing and separation devices and procedures. Reverse osmosis generates large amounts of waste run-off, and filters can become clogged and are costly to replace.

Electrocoalescent treatment of fluids to aid in the separation of components from solutions and mixtures is commonplace in, but not limited to, the industrial waste water treatment field. Electrocoalescence is generally considered an environmentally friendly process for the destabilization and flocculation of suspended, emulsified or dissolved contaminants, as the need for adding exogenous chemicals to the purification scheme is minimized or eliminated and large amounts of excess waste water are also not generated.

Electrostatic treatment of fluids to aid in the separation of components from solutions and mixtures is commonplace in industrial processes. In such liquid component separation schemes, high voltage electric fields are applied to fluids to augment coalescence of immiscible liquid phases. In general, direct current applied to paired metal electrodes, where sacrificial electrodes causes the attraction of ions in solution which contributes to the removal of undesirable contaminants; either by an in-situ chemical reaction and precipitation or by causing colloidal materials to coalesce so to be readily removed by other available means. Oxidation reactions and hydroxyl radical generation also contribute to aggregate formation and the precipitation of component material. Electric fields also tend to increase the size of coalesced droplets in suspension, and therefore increase the speed in which natural, gravity-based phase separation occurs, and also flotation-based and centrifugation-based methodologies.

There is a substantial need for rapid, high throughput fluid component separation, which is cost effective, does not generate large amounts of additional waste, and is not highly solute- or contaminant-specific. Electrocoalescence reactors substantially fill these needs, but they tend to be large devices with limited electrode-pair surface area. The trade-off is either an extremely large reactor with adequate electrode surface, or a small unit that has a relatively low efficiency due to lack of electrode-pair surface area.

Accordingly, there is a need for a high efficiency electrocalescence reactor. This and other objects, features, and advantages in accordance with the present invention are provided by a novel electrocalescence reactor arrangement that efficiently maximizes electrode-pair surface area in a compact reactor assembly.

### SUMMARY OF THE INVENTION

This invention is an apparatus and related methods for the electrocoalescent separation of fluid constituents. The invention comprises a first electrode base, a first substantially parallel electrode array, having a first inner concentric fin and a first outer concentric fin and a plurality of intervening concentric fins, attached to the first electrode base that projects distally from the first electrode base. It also comprises a second electrode base, a second substantially parallel electrode array, having a second inner concentric fin and a second outer concentric fin and a second plurality of intervening concentric fins, attached to the second electrode base that projects distally from the second electrode base and having a sufficient size and dimension to complimentarily interleave the first electrode array thereby forming a continuous interstitial channel and forming an intake chamber substantially defined by the first inner concentric fin. Additionally, a first conductor is in continuity with the first electrode array, and a second conductor in continuity with the second electrode array is also part of the apparatus.

In another embodiment, a reactor vessel surrounds the first electrode base, the first electrode array, the second electrode base, and the second electrode array to define a sealed reaction chamber. A first fastening means attaches the first electrode base to the reactor vessel and a second fastening means attaches the second electrode base to the reactor vessel. The reaction vessel comprises an outlet port situated to allow fluid to exit the reaction chamber. There may also be a second outlet port for draining the reactor vessel.

In another embodiment, there is an outer wall situated between the first electrode base and second electrode base that sealedly surrounds the first electrode array and second electrode array to define a sealed reaction chamber; and an outlet port situated to allow fluid to exit from the reaction chamber. In another embodiment, there is a second outlet port for draining the reactor vessel.

An inlet port proximate the intake chamber allows fluid to enter the interstitial channel. In some embodiments, the inlet port is a high turbulence input port to promote fluid agitation and mixture before the fluid enters the intake chamber.

An electrical circuit between the first conductor and the second conductor generates a voltage potential between the first electrode array and the second electrode array. The apparatus further comprises controls to adjust at least one of voltage and current. The apparatus further comprises an instrument to measure the voltage and current of the system and the electrical continuity between electrodes.

The arrangement of the first electrode array and the arrangement of the second electrode array are substantially a shape selected from the group consisting of a circle, oval, and polygon. The fins of the first electrode array are equidistantly spaced and the fins of the second electrode array are also equidistantly spaced. The conformation of the electrodes may follow a rectangular, circle, oval, square, rectangle, crescent, star, triangle, polygon, pie or other closed shape while following the same operative principle and advantages outlined in present invention.

The invention also encompasses methods for augmenting the coalescence of fluid constituents comprising the steps of providing a first electrode array comprising a first plurality of concentric fins, the first plurality of concentric fins projecting generally normally from a first electrode base. Also providing a second electrode array comprising a second plurality of concentric fins, the second plurality of concentric fins projecting generally normally from a second electrode base. The first electrode array is interleaved into the second electrode array, and the resultant electrode assembly is encased into a reactor vessel. Fluid is administering fluid into an inlet port of the reactor vessel, and a voltage potential is generated between the first electrode array and the second electrode array with a power control circuit. The fluid is passed through an outlet port so that the fluid exits the reaction chamber.

The method also encompasses the step of generating of a voltage potential between the first electrode fin array and the second electrode fin array with a power supply circuit and the passing of fluid through an outlet port so that the fluid exits the reaction chamber. In one embodiment, the power supply circuit comprises controls to adjust at least one of voltage and current. In one embodiment, the power supply circuit comprises an instrument to measure at least one of voltage, current, and resistance of the circuit.

The pressure applied to the fluid regulates fluid flow and therefore the speed the fluid passes through the interstitial channel. In another embodiment, the fluid is exposed to an electromagnetic field prior to flowing into the reaction chamber. In another embodiment, the fluid is subjected to turbulence prior to the injecting to promote fluid turbulence and mixture before the fluid enters the intake chamber.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 illustrates a perspective semi-wireframe view of an exemplary device according to the present invention showing complimentary electrode fin arrays;

FIG. 2 illustrates a perspective semi-wireframe view of an exemplary device according to the present invention showing the relationship between interleaving electrode fin arrays;

FIG. 3 illustrates a cross sectional view taken along the line Y-Y of an exemplary reaction chamber according to the present invention; and

FIG. 4 illustrates a cross sectional view taken along the line Z-Z of an exemplary device according to the present invention.

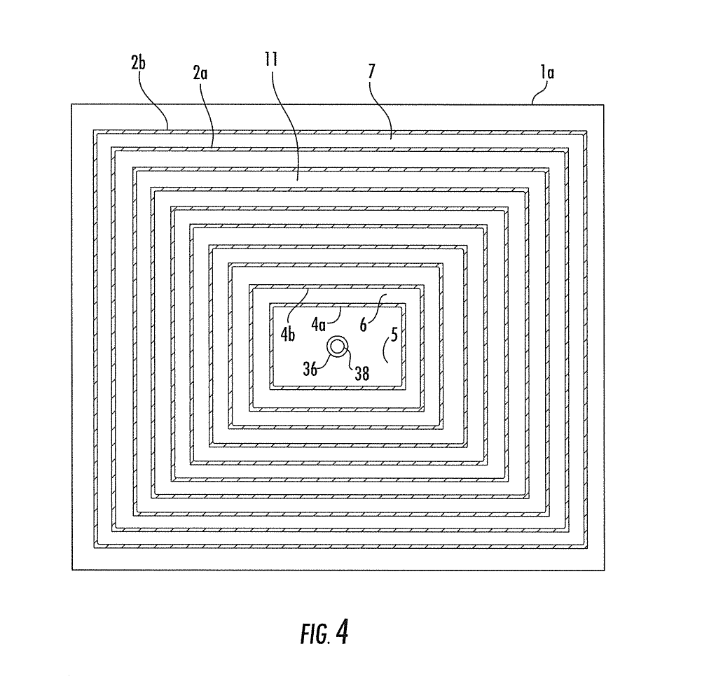

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Electrode Description

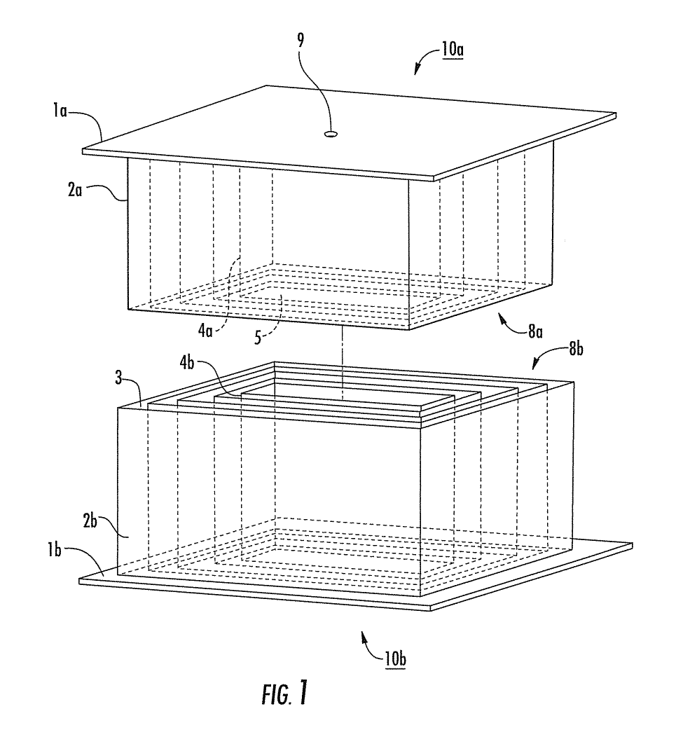

Referring initially to FIG. 1, in one embodiment, a first electrode base 1a serves as a mechanical base and electrical conductor for the first electrode 10a. Attached to the first electrode base 1a is a parallel electrode fin array 8a. This array 8a is a series of electrically conductive fins that distally project substantially perpendicularly from the first electrode base 1a. Each fin of the electrode array 8a is substantially parallel to each other fin of that same array 8a.

The fins of the electrode array 8a are arranged concentrically, and the shape profile of each individual, describing a cross section that is in the same plane as the electrode base 1a, is that of circle, oval, square, rectangle, crescent, star, triangle, polygon, pie or other closed shape.

The first electrode base 1a is made from a metal chosen from the group comprising of aluminum, iron, magnesium, manganese, molybdenum, gold, rhodium, tin, cobalt, copper, lead, nickel, palladium, platinum, silver, titanium, tungsten, zinc, alloys thereof, and any other electrode material known in the art. In a preferred embodiment, the first electrode base 1a is made from iron. The fins of the electrode fin array 8a are made from at least one metal chosen from the group comprising of aluminum, iron, magnesium, manganese, molybdenum, gold, rhodium, tin, cobalt, copper, lead, nickel, palladium, platinum, silver, titanium, tungsten, zinc, combinations thereof, and any other electrode material known in the art. In a preferred embodiment, the first electrode fin array 8a is made from iron.

The fins of the first electrode array 8a are sealedly attached to the first electrode base 1a so that fluid can not leak past the point of attachment. There is electrical continuity between the fins of the first electrode array 8a and the first electrode base 1a. In one embodiment, the fins of the electrode array 8a are at least one of bolted, cast, welded, brazed, and soldered to the first electrode base 1a. In one embodiment, the fins of the first electrode fin array 8a are mechanically attached to the first electrode base using at least one of bolts, screws, rivets, adhesive, electrically conductive adhesive, and any other attachment means known in the art. In one embodiment, at least one of gaskets and sealant is used to prevent leakage of fluid past the point of attachment.

The inner concentric fin 4a of the first electrode 10a substantially defines the intake chamber 5. The first electrode fin array 8a attached to the first electrode base 1a forms a number of separate parallel channels that circumscribe the intake chamber 5. In one embodiment, each concentric fin is equally spaced in a concentric fashion.

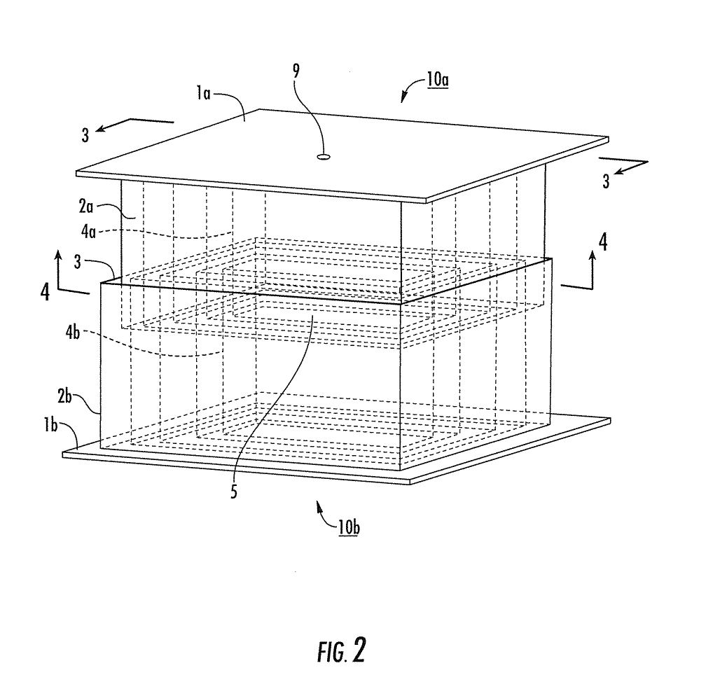

The second electrode 10b, is substantially a mirror of the first electrode 10a, however, the second electrode fin array 8b is spatially offset a sufficient distance so that the second electrode array 8b interleaves the first electrode array 8a. FIG. 2 illustrates one embodiment of the invention wherein electrodes 10a, 10b are interleaved to form the electrode assembly 20. The electrode assembly 20 comprises an interstitial channel 11 as a result of the interleaving electrodes 10a, 10b. The outer channel 3 of the second electrode 10b, after both electrodes interleave, is roughly halved in size by the outer concentric fin 2a of the first electrode 10a, and this splits the outer channel 3 into two sub-channels, the outer sub-channel being referred to as a last parallel sub-channel 7. The interstitial channel 11 originates at the intake chamber 5, and continues from a first parallel sub-channel 6 to a last parallel sub-channel 7.

The size of the individual sub channels of the interstitial channel 11 of the electrode assembly 20 is determined by the spacing between the concentric electrode arrays 8a, 8b. As fluid travels through the interstitial channel 11, the pressure drops as a function of distance from the reactor center. If the fins of an electrode array 8a, 8b are spaced too closely, flow redirection causes a pressure increase. If the fins of an electrode array 8a, 8b are spaced too far apart, the flow decreases, while the system efficiency increases. For most fluids, the spacing between fins of a sub-channel in the interstitial channel 11 is ideally between 2 mm and 25 mm.

### Reactor Vessel Description

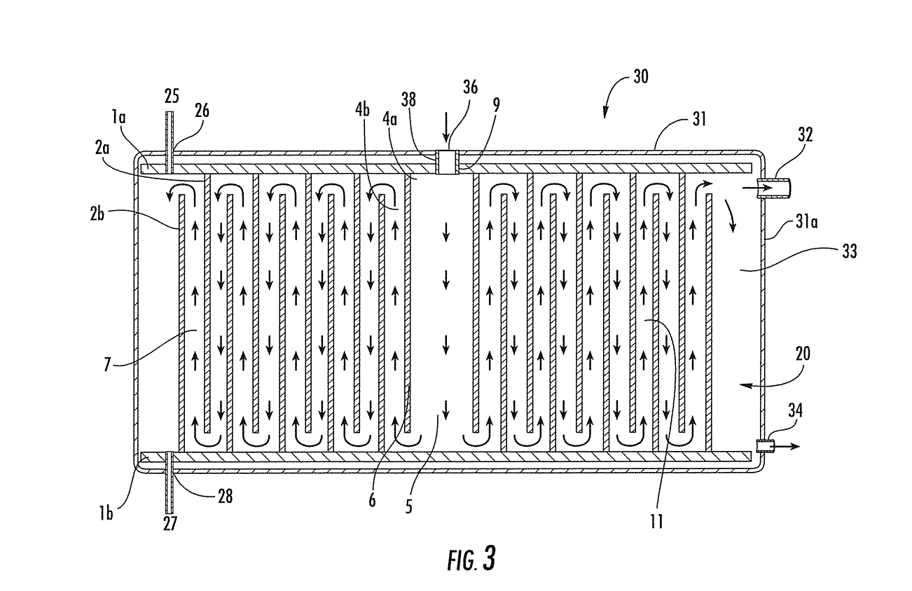

FIG. 3 shows the electrocoalescence assembly 30 comprising the electrode assembly 20 encased within a reactor vessel 31. The reactor vessel 31 is constructed from at least one of plastic, fiberglass, carbon fiber, stainless steel, and any other material known in the art for fabricating such vessels. In one embodiment, the reactor vessel comprises a vessel input port 36 that sealedly communicates with the inlet port 9 of the first electrode 10a. In one embodiment, a conduit 38 communicates with the inlet port 9 and the vessel input port 36. In one embodiment, the conduit 38 creates fluid turbulence.

The electrodes 10a, 10b are attached to the reactor vessel 31 by at least one of mechanical fasteners, hook and loop, adhesive, sealant, and any other method know in the art. A first conductor 25 is attached to the first electrode base 1a, and a second conductor 27 is attached to the second electrode base 1b. The first conductor 25 passes through a first conductor port 26 in the reactor vessel 31, and the second conductor 27 passes through a second conductor port 28 in the reactor vessel. The conductor ports 26, 28 are sealed between the conductors 25, 27 and the reactor vessel 31 using at least one of rubber grommets, sealant, friction fit, and any other sealing means known in the art employed to prevent fluid from escaping the reactor vessel around the conductors 25, 27.

The reactor vessel 31 comprises at least one output port 32. The reactor vessel 31 comprises at least one drain port 34. The output port allows fluid in the electrocoalescence assembly 30 to exit and the drain port 34 allows the drainage of fluid from the reactor vessel 31. In one embodiment, the output port 32 is situated at a height on the side wall 31a of the reactor vessel 31 corresponding with the height of the second outer concentric fin 2b thereby maintaining an effective fluid level in the reactor and avoiding uncontrolled drainage of the electrocoalescence assembly 30.

### Reactor Operation

Fluid enters the electrocoalescence assembly 30 through the vessel input port 36 and then enters the intake chamber 5 through an inlet port 9 that is connected to the vessel input port by a conduit 38. Once in the intake chamber 5, the fluid travels into the first sub-channel 6 of the interstitial channel 11 and travels outwardly from the intake chamber 5 in a sinusoidal-like path towards the last parallel sub-channel 7 and into the extra-electrode assembly space 33 of the reactor vessel 31. Due to the concentric configurations of the fins of the electrode arrays 8a, 8b and electrode assembly 20, the time exposure of fluid increases in a semi-logarithmic fashion and separation efficiency increases for the effective treating surface area of paired electrodes (i.e. parallel sub-channel arrangement) as the fluid progresses through the interstitial channel 11.

In one embodiment of the invention, prior to entering the electrocoalescence assembly 30 through the vessel input port 36, the fluid is exposed to a high-turbulence input nozzle that creates liquid turbulence and mixture before the fluid enters into the intake chamber 5. This aids in the homogenization of any particles in suspension and minimizes the settling of particles in the electrode assembly 20 and the reactor vessel 31.

The electrodes 25, 27 are connected to an electrical circuit capable of generating a voltage potential between the electrode fin arrays 8a, 8b thereby creating a potential between an anode and a cathode for hydrolysis reactions. The voltage potential necessary to produce a reaction to neutralize particle charge and initiate coagulation varies depending on the fluid flow rate, the temperature of the fluid, the pressure of the system, the fluid undergoing decontamination, and the contaminants in the fluid, but the voltage range is well known in the art, and generally from −5 VDC to +5 VDC.

The electrical circuit comprises a means to adjust at least one of voltage and current. These values are measured by either analog or digital indicators, such as needle gauges and electronic meters.

### Method of Electrocoalescent Fluid Phase Separation

By way of example, a method for augmenting the coalescence of fluid constituents begins by introducing a fluid into an electrocoalescence assembly 30 by traveling through a vessel input port 36 through a conduit 38 through an inlet port 9 of a first electrode 10a, and into an intake chamber 5. Pressurizing the fluid so that the fluid flows from the intake chamber 5 into a first parallel sub-channel 6, and travels through a series of interleaving electrode fin arrays 8a, 8b that define a plurality of sub-channels that together define a single sinusoid-like interstitial channel 11 that is necessary for operation of the system. The fluid travels through the interstitial channel 11 past a last parallel sub-channel 7 and into an extra-electrode assembly space 33 of the reactor vessel 31.

Generating a voltage potential between the electrode fin arrays 8a, 8b is necessary to create a hydrolysis reaction utilizing the fluid flowing through the electrocoalescence assembly 30. Exposure of the fluid to the electric field and ionizing properties of the hydrolytic circuit causes destabilization and aggregation of smaller particles into larger particles promoting particle coalescence. Additionally, water contaminants, such as ions and colloids are destabilized, therefore promoting aggregation.

Releasing the fluid from the reactor vessel 31 through an output port 34 after the fluid passes through the electrodes 10a, 10b within the reactor vessel 31 finalizes one embodiment of the basic method of for augmenting the coalescence of fluid. In another embodiment, fluid exiting the reactor vessel 31 is exposed to a magnetic field to help augment the coalescence of liquid constituents. The liquid may be exposed before it is introduced into the electrocoalescence assembly 30, after it exits electrocoalescence assembly 30, or at both points. In one embodiment, the liquid released from the reactor vessel 31 passes into at least one of a settling tank, centrifuge, and filtration apparatus.

In one embodiment, fluid is exposed to turbulent forces before it is introduced into the either the electrocoalescence assembly 30 or the electrode assembly 20. In one embodiment, the turbulent forces are generated by a conduit 38 designed to introduce fluid turbulence.

In one embodiment, regulating pressure is a step in the process utilized to adjust the time in which a fluid is exposed to electrodes 10a, 10b.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An apparatus for the electrocoalescent separation of fluid constituents, the apparatus comprising:
a first electrode base;
a first electrode array having a first inner concentric fin and a first outer concentric fin and a plurality of intervening concentric fins, the first electrode array fitted with the first electrode base and projecting generally normally from the first electrode base;
a second electrode base;
a second electrode array having a second inner concentric fin and a second outer concentric fin and a second plurality of intervening concentric fins, the second electrode array fitted with the second electrode base and projecting generally normally from the second electrode base and having a sufficient size and dimension to complimentarily interleave with the first electrode array so to form a continuous interstitial channel and an intake chamber substantially defined by the first inner concentric fin; and
a first conductor in continuity with the first electrode array, and a second conductor in continuity with the second electrode array.

2. The apparatus of claim 1, further comprising:
a reactor vessel that surrounds the first electrode base, first electrode array, second electrode base, and second electrode array to define a sealed reaction chamber.

3. The apparatus of claim 2, further comprising:
fastening means for attaching the first electrode base to the reactor vessel; and
fastening means for attaching the second electrode base to the reactor vessel.

4. The apparatus of claim 2, further comprising an outlet port situated to allow fluid to exit from the reaction chamber.

5. The apparatus of claim 2, further comprising a second outlet port for draining the reactor vessel.

6. The apparatus of claim 1, further comprising:
an outer wall situated between the first electrode base and second electrode base that sealedly surrounds the first electrode fin array and second electrode array to define a sealed reaction chamber; and
an outlet port situated to allow fluid to exit from the reaction chamber.

7. The apparatus of claim 6, further comprising a second outlet port for draining the reactor vessel.

8. The apparatus of claim 1, further comprising an inlet port proximate the intake chamber that allows fluid to enter the interstitial channel.

9. The apparatus of claim 8, wherein the inlet port is a high turbulence input port to promote fluid turbulence and mixture before the fluid enters the intake chamber.

10. The apparatus of claim 1, further comprising an electrical circuit between the first conductor and the second conductor capable of generating a voltage potential between the first electrode array and the second electrode array.

11. The apparatus of claim 10, further comprising means for adjusting at least one of voltage, current, and resistance of the circuit.

12. The apparatus of claim 10, further comprising an instrument to measure at least one of voltage, current, and resistance of the circuit.

13. The apparatus of claim 1 wherein the fins of the first electrode array and the fins of the second electrode array form closed nestable shape profiles selected from the group comprising one of a circle, oval, crescent, pie, and polygon.

14. The apparatus of claim 1 wherein, the fins of the first electrode array are equidistantly spaced and the fins of the second electrode array are equidistantly spaced.

15. A method for augmenting coalescence of fluid constituents, the method comprising the steps of:
providing a first electrode array comprising a first plurality of concentric fins, the first plurality of concentric fins projecting generally normally from a first electrode base;
providing a second electrode array comprising a second plurality of concentric fins, the second plurality of concentric fins projecting generally normally from a second electrode base;
interleaving the first electrode array into the second electrode array, defining an interstitial channel;
encasing the interleaved electrode arrays in a reaction chamber;
administering fluid into an inlet port of the reaction chamber, the inlet port leading to an intake chamber;
generating a voltage potential between the first electrode array and the second electrode array with a power control circuit; and
passing the fluid through an outlet port so that the fluid exits the reaction chamber.

16. The method of claim 15, further applying pressure to the fluid for regulating fluid flow and therefore a speed with which the fluid passes through the interstitial channel.

17. The method of claim 15, further comprising exposing the fluid to an electromagnetic field at least one of prior to flowing and after flowing into the reaction chamber.

18. The method of claim 15, further comprising subjecting the fluid to turbulence prior to the injecting to promote fluid turbulence and mixture before the fluid enters the intake chamber.

19. The method of claim 15, further comprising controlling at least one of voltage and current of the power control circuit.

20. The method of claim 15, further comprising measuring at least one of voltage and current of the power control circuit.
